(19) United States
(12) Patent Application Publication
(10) Pub. No.: US 2007/0252568 A1
(43) Pub. Date: Nov. 1, 2007

(54) REFERENCE VOLTAGE GENERATOR, FREQUENCY GENERATOR AND CONTROLLER

(75) Inventor: Huan-Wen Chien, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BEYOND INNOVATION TECHNOLOGY CO., LTD., Taipei (TW)

(21) Appl. No.: 11/463,612

(22) Filed: Aug. 10, 2006

(30) Foreign Application Priority Data
May 1, 2006 (TW) 95115460

(51) Int. Cl. G05F 1/00

(52) U.S. Cl. 323/284

(57) ABSTRACT

A controller comprises an error comparator, a frequency generator, a pulse-width modulator and an output driver. The error comparator generates an error signal according to a feedback signal and a reference voltage. The frequency generator provides a frequency signal. The pulse-width modulator coupled to the error comparator and the frequency generator generates a pulse-width modulated signal according to the error signal and the frequency signal. The output driver coupled to the pulse-width modulator generates at least one switch signal according to the pulse-width modulated signal. Because the frequency signal is within at least one of the first predetermined bandwidths of the frequency range during a second predetermined time interval is within a third predetermined number, beat frequency interference is not detectable by users.

### BACKGROUND OF THE INVENTION

1. Field of the Invention

The invention relates to a voltage generator for generating reference voltage and a frequency generator and a controller using the voltage generator, and in particular to a voltage generator for generating random reference voltage and a frequency generator controlled by the voltage generator.

2. Description of the Related Art

Conventional reference voltage generators provide a precise reference voltage unaffected by temperature and power supply, enabling other components to generate precise results according to the reference voltage.

For example, FIG. 1A is a conventional buck converter 100 comprising controller 110, step-down module 120 and load 130. Controller 110 comprises reference voltage generator 111, frequency generator 112, pulse-width modulator 114, output driver 116 and feedback controller 118. A precise reference voltage is provided to frequency generator 112 and feedback controller 118 by reference voltage generator 111 according to a signal detected by detection circuit 132 and the reference voltage provided by reference voltage generator 111 for adjusting the output condition of buck converter 100. A triangular wave signal and a pulse signal with the same frequency generated by frequency generator 112 according to the reference voltage provided by reference voltage generator 111, and the triangular wave signal and the pulse signal are sent to pulse-width modulator 114 and output driver 116 respectively. A pulse-width modulated signal is generated by pulse-width modulator 114 according to the feedback signal and the triangular wave signal. The pulse-width modulated signal is thus sent to output driver 116. A switched signal is generated by output driver 116 according to the pulse signal and the pulse-width modulated signal.

Step-down module 120 comprises switch 122, inductor 124, diode 126 and capacitor 128. Switch 122 is connected to DC voltage source VDC and operates according to the switched signal to control the time that the power of DC voltage source VDC input to step-down module 120. The voltage of DC voltage source VDC is reduced by inductor 124, diode 126 and capacitor 128 to provide a steady and a reduced DC voltage to load 130.

As described, an operating frequency is generated by frequency generator 111 according to the reference voltage and the calculation of the feedback controller is performed according to the reference voltage and the detected signal. Here, frequency generator 112 is given as an example to describe below.

FIG. 1B illustrates a conventional frequency generator. Frequency generator 112 comprises first comparator 152, second comparator 154, NAND gates 156 and 158, third comparator 160, switches 162 and 164, charging current source 166, discharging current source 168 and capacitor 170. First compared voltage Vref1 and second compared voltage Vref2 is provided by reference voltage generator 111 to determine the peak voltage and the valley voltage of the triangular wave. When output voltage Vout is charged to exceed first compared voltage Vref1, third comparator 160 outputs a high voltage level signal, switch 162 turns off and charging current source 166 stops charging capacitor 170, and switch 164 will turn on and discharging current source 168 starts discharging capacitor 170. Therefore, output voltage Vout begins decreasing. When output voltage Vout is decreased below second compared voltage Vref2, third comparator 160 outputs a low voltage level signal, switch 164 turns off and discharging current source 168 stops discharging capacitor 170. Switch 162 turns on and charging current source 166 starts charging capacitor 170. After that, output voltage Vout begins increasing. Due to the described charging/discharging process, third comparator 160 outputs the pulse signal and capacitor 170 outputs the triangular wave signal with the same frequency.

Note that the frequency characteristics of the load, operational frequency range of the switch, the frequency response of other components (such as resonant components), beat frequencies must be considered in the design of the frequency generated by the frequency generator. Thus, many conditions must be considered when choosing the generated frequency.

Since a system (such as an LCD) comprises a plurality of modules and each module has it own operating frequency, the beat frequencies caused by different operating frequencies affect the representation of an image, for example the image of an LCD may comprise ripples when these operating frequencies are not synchronized. The design of such a system may be complicated as beat frequencies are difficult to completely prevent.

### BRIEF SUMMARY OF INVENTION

A detailed description is given in the following embodiments with reference to the accompanying drawings.

The invention provides a random or random-like frequency signal such that the interference effect caused by different frequencies will not accumulate. Thus, dispersed interference is not detectable by users. That is, the interference is not detectable when the frequency generated by the frequency generator varies within a predetermined frequency range and the average interferences in at least one predetermined bandwidth of the predetermined frequency range are within a predetermined percentage during a predetermined time interval.

The invention provides a reference voltage generator comprising a reference voltage generating unit generating a first reference voltage; an irregular signal generator generating an irregular signal; and a processing unit coupled to the reference voltage generating unit and the irregular signal generator to output a second reference voltage according to the first reference voltage and the irregular signal.

The invention also provides a frequency generator comprising a frequency generating unit generating a frequency signal; and a frequency adjusting unit coupled to the frequency generating unit to control the frequency of the frequency signal. The number of frequency signals generated at least one first predetermined bandwidth within the frequency range of the frequency signal during a second predetermined time interval is less than a third predetermined number.

The invention also provides a controller comprising an error comparator, a frequency generator, a pulse-width modulator and an output driver. An error signal is generated by the error comparator according to a feedback signal and a reference voltage. A frequency signal is provided by the frequency generator. The pulse-width modulator coupled to the error comparator and the frequency generator generates a pulse-width modulated signal according to the error signal and the frequency signal. The output driver coupled to the pulse-width modulator to generate at least one switched signal according to the pulse-width modulated signal, wherein the switched signal has a frequency varying within a predetermined range.

### BRIEF DESCRIPTION OF DRAWINGS

The invention can be more fully understood by reading the subsequent detailed description and examples with references made to the accompanying drawings, wherein:

FIG. 1A illustrates a schematic view of a conventional buck converter.

FIG. 1B illustrates a schematic view of a conventional frequency generator.

FIG. 2A illustrates a schematic view of a preferred embodiment of a reference voltage generator.

FIG. 2B illustrates a schematic view of another preferred embodiment of a reference voltage generator.

FIG. 3 illustrates a schematic view of the reference voltage Vref′ shown in FIG. 2A and FIG. 2B.

FIG. 4 illustrates a schematic view of the triangular wave signal generated by the frequency generator when the second reference voltage Vref2 of the frequency generator shown in FIG. 1 B is random reference voltage Vref′.

FIG. 5 illustrates a schematic view of a random current source.

FIG. 6 illustrates using a converting controller of the frequency generator with random frequency.

FIG. 7A illustrates a schematic view of conventional difference frequency interference.

FIG. 7B illustrates a schematic view of the difference frequency interferences of the invention.

FIG. 8 illustrates a schematic view of the converting controller of the frequency generator of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention is to generate a random or random-like frequency signal such that the interference effect caused by the difference frequencies is not accumulated. Thus, the dispersed interference is not detectable by users.

The random or random-like frequency signal can be generated according to a reference signal and a stable signal. The reference signal could be generated by drift of device characteristic or programmable components.

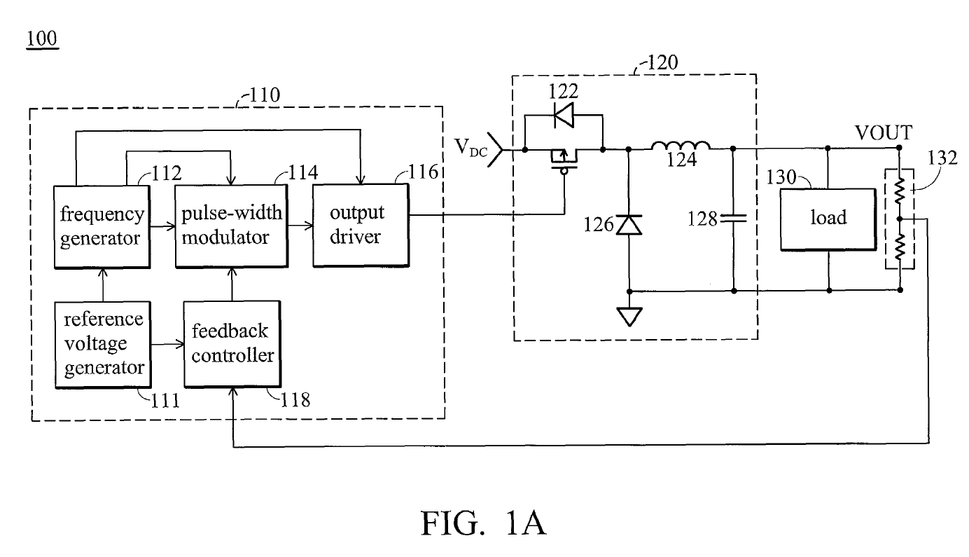

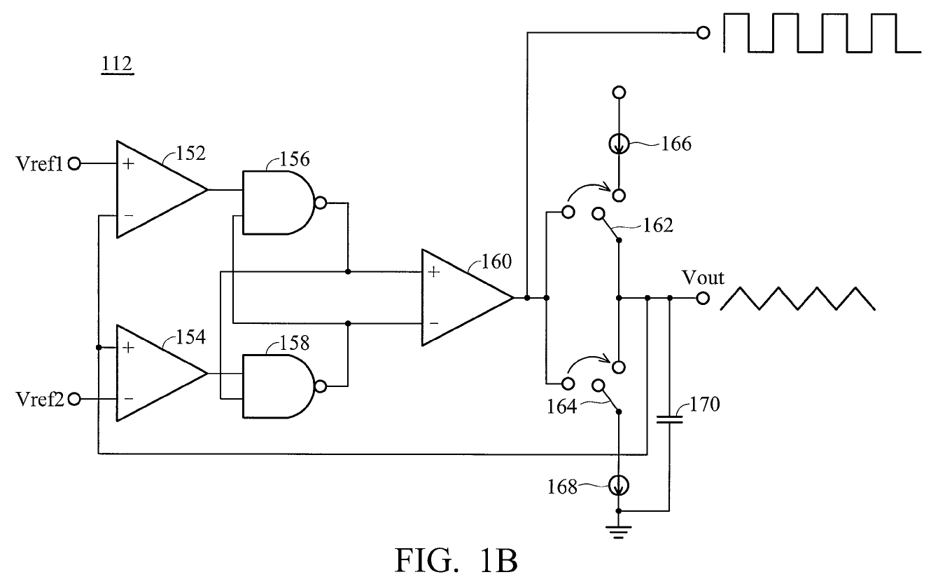

Referring to FIG. 1B, the conventional frequency generator 112 requires stable current source 166 and 168, stable capacitor 170, stable first compared voltage Vref1 and stable second compared voltage Vref2 to generate a triangular wave signal and a pulse signal with stable frequency. As long as one of the above characteristics has random or random-like variation, the triangular wave signal and pulse signal generated by frequency generator 112 may have a random or random-like frequency.

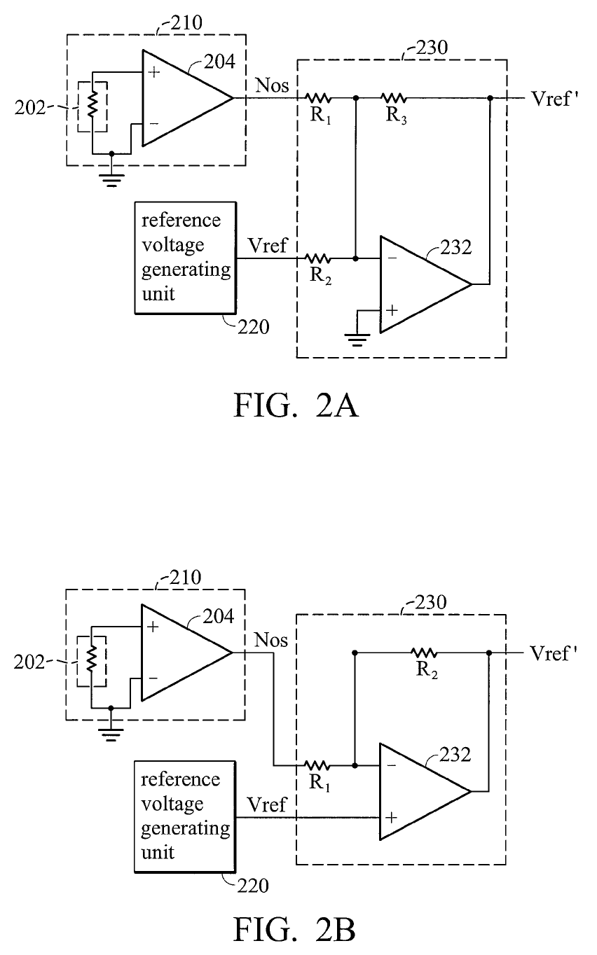

FIG. 2A illustrates a schematic view of a preferred embodiment of a reference voltage generator. The reference voltage generator comprises irregular signal generator 210, reference voltage generating unit 220 and processing unit 230. Irregular signal generator 210 comprises resistor 202 and amplifier 204. Thermal noise of resistor 202 may be amplified by amplifier 204 to generate random noise Nos (an irregular signal). A stable reference voltage Vref is provided by reference voltage generating unit 220. Processing unit 230 may be an analog adder that comprises resistor R1, R2 and R3 and amplifier 232. The analog adder adds noise Nos and reference voltage Vref up and outputs a random reference voltage Vref′. The random reference voltage Vref is provided to the frequency generator as shown in FIG. 1B as first compared voltage Vref1 or second compared voltage Vref2 such that triangular wave signal and random pulse signal with a random frequency may be generated by the frequency generator.

FIG. 2B illustrates a schematic view of another preferred embodiment of the reference voltage generator. The main difference between the reference voltage generators as shown in FIG. 2B and FIG. 2A is the component of processing unit 230. Processing unit 230 shown in FIG. 2B comprises resistor R1, R2 and comparator 232. The operation of processing unit 230 shown in FIG. 2B is similar to that in FIG. 2A and is not described here.

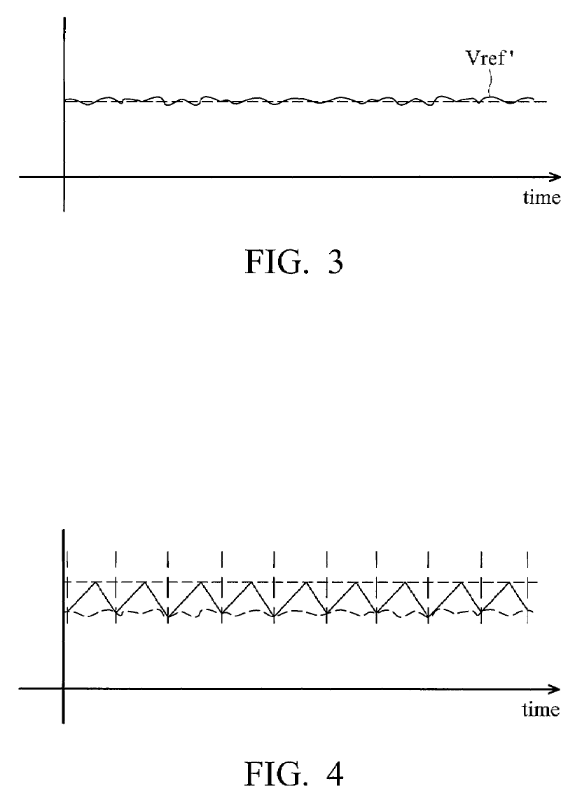

FIG. 3 illustrates a schematic view of random reference voltage Vref′, wherein the dotted line is the value of reference voltage Vref after processing and the difference between the solid line and the dotted line is noise Nos. As can be seen in the FIG. 3, random reference voltage Vref′ can vary within a predetermined range since the noise Nos is not large relatively to reference voltage Vref. Thus, the effect of the variations on system stability can be reduced.

FIG. 4 illustrates a schematic view of the triangular wave signal generated by the frequency generator, where second reference voltage Vref2 of the frequency generator shown in FIG. 1B is reference voltage Vref. As can be seen in FIG. 4, the time interval is not the same because the valley values of two adjacent triangular wave signals are not the same. That is, the frequency is variable. A random frequency signal (such as the triangular wave signal and the pulse signal) may be generated when the reference voltage generated by the reference voltage generator of the invention is provided to the frequency generator. Certainly, reference voltage Vref may be taken as first reference voltage Vref1 of FIG. 1 B or two different reference voltages Vref′ may be taken as first reference voltage Vref1 and second reference voltage Vref2 respectively simultaneously.

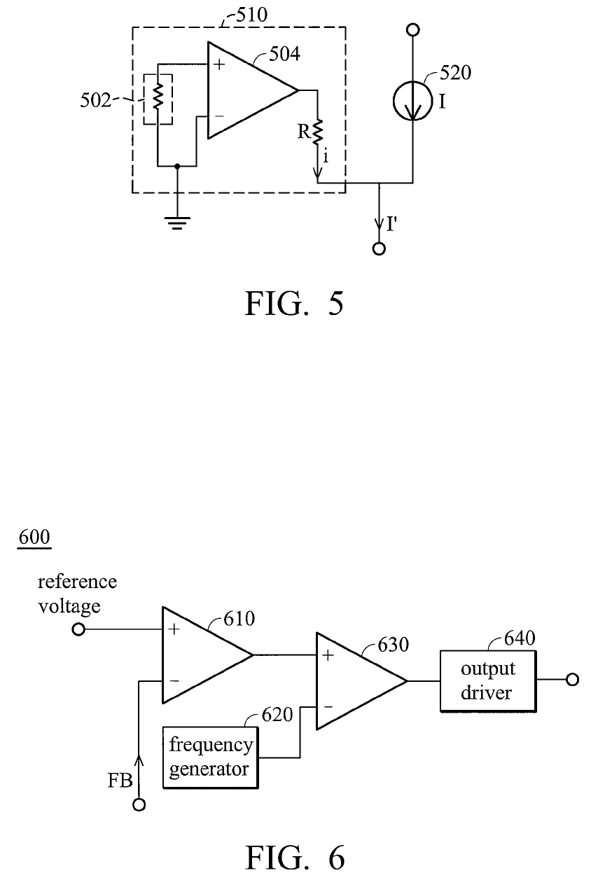

FIG. 5 illustrates a schematic view of a random current source. The current source comprises irregular current source 510 and fixed current source 520. Irregular current source 510 comprises resistor 502, amplifier 504 and resistor R. The thermal noise of resistor 502 is amplified by amplifier 504 to generate a random noise voltage signal. The random noise voltage signal passes through resistor R to generate an irregular current i. The irregular current i is combined with a fixed current I to generate a random current I′. Current I′ can vary within a predetermined range when irregular current I is relatively smaller than fixed current I. Similarly, a random frequency signal (such as a triangular wave signal and a pulse signal) can be generated when the charging current source and/or the discharging current source of the frequency generator shown in FIG. 1B is the described random current source.

The difference between the random frequency signal generated by a random current source and that generated by a random reference voltage is that the slope of the triangular wave signal of the random frequency signal generated by random current source may change randomly, while the values of the peak voltage or the valley voltage of the triangular wave signal of the random frequency signal is generated by a random reference voltage. The random frequency signal generated by the random current source or the random reference voltage is determined according to different applications.

Note that the average power of the noise is approximate zero. Thus, system stability is not influenced under long time interval. Thus, the random current source and the random reference voltage source of the invention or any circuit (such as frequency generator) using the current source or reference voltage source described above are suitable for a system with feedback control and will not affect system stability.

FIG. 6 illustrates a schematic view of DC/AC (or DC/DC) converting controller 600 with random frequency generator. Converting controller 600 comprises error comparator 610, frequency generator 620, pulse-width modulator 630 and output driver 640. Error comparator 610 compares the reference voltage and feedback signal FB to output an error signal. Pulse-width modulator 630 is coupled to error comparator 610 and frequency generator 620. Pulse-width modulator 630 generates a pulse-width modulated signal to output driver 640 according to the error signal and the triangular wave signal generated by frequency generator 620. Then, a switch signal is generated by output driver 640 according to the pulse-width modulated signal to control the power switch. The frequencies of the pulse-width modulated signal and the switch signal generated by the triangular wave signal may change randomly due to the random frequency of the triangular wave signal of frequency generator 620.

In addition to the random signal generated by a noise resistor or other device, the random-like signal could be generated by a digital circuit to randomly vary the signal frequency generated by the frequency generator. The random-like signal can still make the interference of beat frequency be undetectable by the users as long as the interference is not detectable within the user detectable frequency range. For example, human eye can detect an interference that has a frequency lower than 200 Hz and a magnitude larger than a certain value. Therefore, as long as each variation or accumulated variation under 200 Hz is lower than a minimum detectable valve, , said variation can be undetectable to the eye. This can be achieved by generating a frequency with regular and equal variation such that each variation or accumulated variation is undetectable within the detectable interference frequency range. Here, take vision as an example.

An LCD comprises multiple components with different operating frequencies. Thus, it is impossible to prevent all interference of beat frequencies between all operating frequencies. For example, the operating frequency of a component is f1, and the value of f1 is unknown. Since the value of f1 is unknown, the operating frequency f2 of another component to prevent interference can not be determined. The invention is to change the frequency of f2 within a predetermined range, and the accumulated interference of f2 within each 200 Hz is less than the detectable range or percentage of user vision (for example the percentage of luminance interference is less than 0.4%). In other words, the interference is dispersed on each frequency, and only part of the interference can be detected. Thus, the interference can be reduced. For example, assume the interference between the converter and another component with different operating frequency is 0.03% (X), the operating frequency of the converter varies within the range of 49˜51 KHz, the operating frequency of the converter changes 60 Hz every 1 ms (that is the frequency variation of 1 KHz is Y times of 200 Hz, wherein Y is greater than or equal to 1, and in the embodiment Y is 5). Note that 60 Hz is larger than ¼ of 200 Hz (z is defined as the maximum number fall within 200 Hz in 5 ms, and in the embodiment Z is 4). As long as (X/Y)*Z≦0.4%, the interference can not be detected by users. The embodiment (X/Y)*Z=(0.03%/5)*4=0.024%<0.4% meets the requirement. The variation in 5 ms may be accumulated and be averaged, since a user eyes can not identify the variation greater than 200 Hz (in 5 ms). Therefore, X/Y represents the accumulated average visually detectable interference each time before changing the operating frequency, z represents the amount of visually detectable interference frequency within range, for example assume the initial beat frequency of f1 and f2 is 10 Hz, the difference frequency of f1 and f2 first becomes 70 Hz (increased by 60 Hz), second becomes 70 Hz, fourth becomes 190 Hz, and these four beat frequencies occur within 5 ms. Thus, the largest possible total interference must be multiplied by z.

Assume the maximum user detectable frequency is fHz and the minimum detectable magnitude is d, the interference can not be detected when the number of occurrences interferences within fHz is less than a predetermined number (let the average interference be less than d).

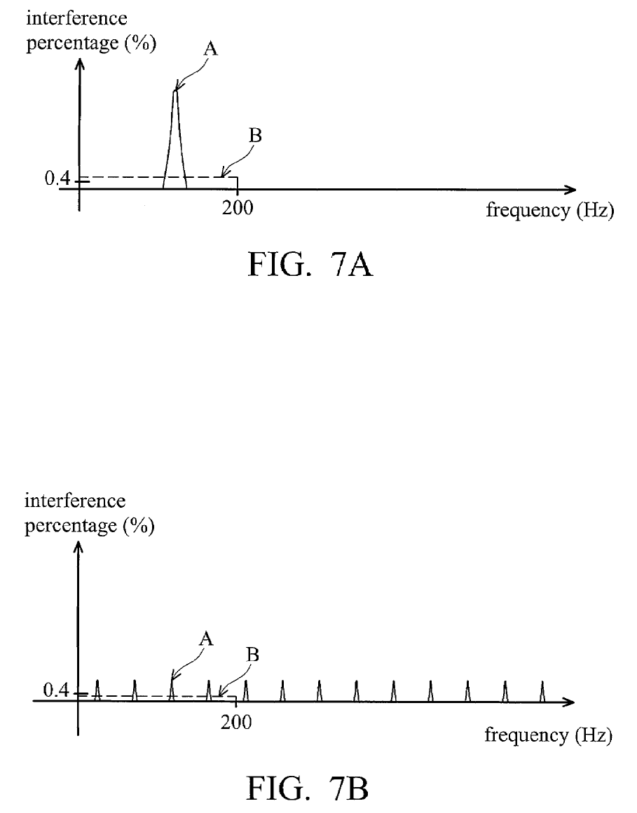

FIG. 7A illustrates a schematic view of conventional difference frequency interference. The average interference of beat frequency is greater than 0.4%, which is visually detectable (the average interferences is noted as B) since the interference power of beat frequency A falls almost on the same frequency. As shown in FIG. 7B, the average interference within 200 Hz is less than 0.4% which is not visually detectable (the average interference is noted as B), since interferences of beat frequency A in FIG. 7B is dispersed to all frequencies.

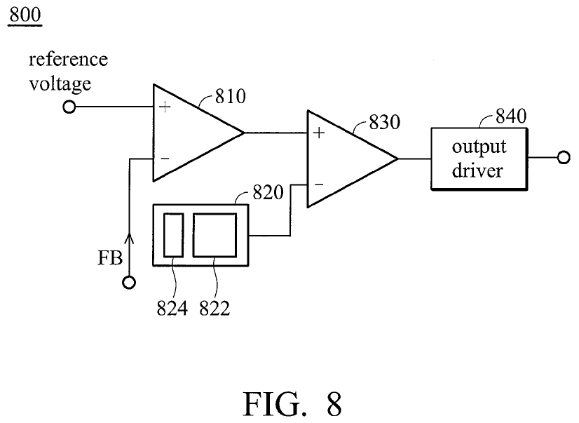

FIG. 8 illustrates a schematic view of converting controller 800 using the frequency generator described above. Converting controller 800 comprises error comparator 810, frequency generator 820, pulse-width modulator 830 and output driver 840. Error comparator 810 compares a reference voltage and feedback signal FB to generate an error signal. Pulse-width modulator 830 is coupled to error comparator 810 and frequency generator 820. Pulse-width modulator 830 generates a pulse-width modulated signal according to the error signal and a triangular wave signal generated by frequency generator 820, and the pulse-width modulated signal is sent to output driver 840. Then, output driver 840 generates a switch signal according to the pulse-width modulated signal to control the operation of the power switch. Frequency generator 820 comprises frequency generating unit 822 and frequency adjusting unit 824. Frequency adjusting unit 824 is coupled to frequency generating unit 822 to control the variation of the output frequency, for example controlling the current output from the current source, the capacitor or the compared voltages of the frequency generator to change the output frequency. Frequency adjusting unit 824 controls the frequency generated by frequency generating unit 822 varying within a predetermined range, and the average interference in a predetermined time interval (depending on a time interval detectable by a user, such as 5 ms) of at least one predetermined bandwidth (depending on the bandwidth detectable by a user, such as 200 Hz) of the predetermined range is within a predetermined percentage (depending on the variation percentage detectable by a user, such as 0.4%). Frequency adjusting unit 824 can be an analog circuit (such as the irregular signal generator or the irregular current source of the embodiment described above) or a digital circuit (can be implemented by a micro-controller). If the bandwidth of the predetermined beat frequency can not be expected to specify the bandwidth of beat frequency, the average interference in a predetermined time interval within any predetermined bandwidths is adjusted to be less than a predetermined percentage such that all possible beat frequency interference can be prevented.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A reference voltage generator, comprising:
a reference voltage generating unit generating a first reference voltage;
an irregular signal generator generating an irregular signal; and
a processing unit coupled to the reference voltage generating unit and the irregular signal generator to output a second reference voltage according to the first reference voltage and the irregular signal.

2. The reference voltage generator as claimed in claim 1, wherein the irregular signal generator comprises a noise resistor and an amplifier, the irregular signal is generated according to a noise of the noise resistor.

3. The reference voltage generator as claimed in claim 1, wherein the processing unit is an analog adder.

4. The reference voltage generator as claimed in claim 1, wherein the second reference voltage is varying within a predetermined range.

5. A frequency generator, comprising:
a frequency generating unit generating a frequency signal; and
a frequency adjusting unit coupled to the frequency generating unit to adjust the frequency of the frequency signal;
wherein the number of the frequency signal generated at least one first predetermined bandwidth within the frequency range of the frequency signal during a second predetermined time interval is less than a third predetermined number.

6. The frequency generator as claimed in claim 5, wherein the frequency adjusting unit is an analog circuit.

7. The frequency generator as claimed in claim 6, wherein the analog circuit controls a capacitor, a current, a compared voltage of the frequency generating unit or the combination thereof.

8. The frequency generator as claimed in claim 7, wherein the analog circuit comprises a noise resistor and an amplifier, an irregular signal is generated by the amplifier according to the noise of the noise resistor to control the frequency of the frequency signal.

9. The frequency generator as claimed in claim 8, wherein the processing unit is an analog adder.

10. The frequency generator as claimed in claim 5, wherein the frequency of the frequency signal varies within a predetermined range.

11. The frequency generator as claimed in claim 7, wherein the analog circuit comprises an irregular signal generator, an irregular current is generated by the irregular signal generator through a resistor to control the frequency of the frequency signal.

12. The frequency generator as claimed in claim 11, wherein the irregular signal generator comprises a noise resistor and an amplifier, the irregular signal is generated by the amplifier according to the noise of the noise resistor.

13. The frequency generator as claimed in claim 5, wherein the frequency adjusting unit is a digital circuit.

14. A controller, comprising:
an error comparator generating an error signal according to a feedback signal and a reference voltage;
a frequency generator providing a frequency signal;
a pulse-width modulator coupled to the error comparator and the frequency generator generating a pulse-width modulated signal according to the error signal and the frequency signal; and
an output driver coupled to the pulse-width modulator generating at least one switch signal according to the pulse-width modulated signal;
wherein the switch signal has a frequency varying within a predetermined range.

15. The controller as claimed in claim 14, wherein the frequency generator comprises:
a frequency generating unit generating a frequency signal; and
a frequency adjusting unit coupled to the frequency generating unit to control the frequency of the frequency signal;
wherein the number of the frequency signal generated at least one first predetermined bandwidth of the frequency range during a second predetermined time interval is less than a third predetermined number.

16. The controller as claimed in claim 15, wherein the frequency adjusting unit is an analog circuit.

17. The controller as claimed in claim 16, wherein the analog circuit controls a capacitor, a current, a compared voltage of the frequency generating unit or the combination thereof.

18. The controller as claimed in claim 15, wherein the frequency adjusting unit is a digital circuit.

19. The controller as claimed in claim 14, wherein the frequency generator comprising:
a triangular wave generating unit comprising a capacitor, a charging unit and a discharging unit, and the capacitor is charged and discharged by the charging unit and the discharging unit in turn to generate a triangular wave signal; and
a reference voltage generator coupled to the triangular wave generator determining an amplitude of the triangular wave signal;
wherein a first reference voltage generated by the reference voltage generator to provide to the triangular wave generator is changed with time.

20. The controller as claimed in claim 19, wherein the reference voltage generator comprising:
a reference generating unit generating a second reference voltage;
an irregular signal generator generating an irregular signal; and
a processing unit outputting the first reference voltage according to the second reference voltage and the irregular signal.

21. The controller as claimed in claim 20, wherein the irregular signal generator comprising a noise resistor and an amplifier, the irregular signal is generator by the amplifier according to the noise of the noise resistor.

22. The controller as claimed in claim 14, wherein the frequency generator comprising:
a triangular wave generating unit comprising a capacitor, a charging unit and a discharging unit and the capacitor is charging and discharging by the charging unit and the discharging unit in turn to generate a triangular wave signal;
a reference voltage generator coupled to the triangular wave generating unit determining an amplitude of the triangular wave signal;
wherein at least one of the charging unit and the discharging unit is an unit changed with time.

23. The controller as claimed in claim 22, wherein at least one of the charging unit and the discharging unit comprises a fixed current source and an irregular current source.

24. The controller as claimed in claim 23, wherein the irregular current source comprises an irregular signal generator, and an irregular current is generated by the irregular signal generator through a resistor.

25. The controller as claimed in claim 24, wherein the irregular signal generator comprises a noise resistor and an amplifier, and the irregular signal is generated by the amplifier according to the noise of the noise resistor.
